(19) United States
(12) Patent Application Publication
(10) Pub. No.: US 2006/0081108 A1
(43) Pub. Date: Apr. 20, 2006

(54) Manual safety vegetable cutter

(75) Inventor: Julien de Buyer, Le Val d'Ajol (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: DE BUYER, Le Val d'Ajol (FR)

(21) Appl. No.: 11/010,585

(22) Filed: Dec. 13, 2004

(30) Foreign Application Priority Data
Oct. 15, 2004 (FR) 04 10 911

(51) Int. Cl. B26D 7/06

(52) U.S. Cl. 83/703

(57) ABSTRACT

Manual safety vegetable cutter comprising:
a frame (1) which is supported on feet (2₁, 2₂) and which is provided with two parallel longitudinal uprights (3₁, 3₂) which define two guiding rails for a carriage (5) which can be moved back and forth in translation and which are connected by means of a plate (4) for adjusting the cutting width, and
at least one cutting blade (11) which is mounted transversely between the longitudinal uprights (3₁, 3₂),
   characterised in that it is provided with at least one removable disc-cutting cartridge (15) which can be inserted longitudinally between the uprights (3₁, 3₂) of the frame (1) and which comprises a first edge (14), on which the cutting blade (11) is mounted, this disc-cutting cartridge (15) being provided with gripping means which co-operate with positioning means which are provided on the frame (1).

The present invention relates to a manual safety vegetable cutter for both domestic and professional use.

According to the invention, the word “vegetables” should be understood in a very broad sense and the vegetables which are cut may be not only any type of vegetable in the strict sense, but also fruit or other foods suitable for being cut.

There are currently on the market various types of manual vegetable cutter which have in common that they are not very practical and expose their users to serious risks of cuts to the hands.

At the same time, there are also many vegetable cutters or electric food processors of a versatile nature intended for domestic use or for industries or collectives.

As a general rule, however, these are sophisticated appliances which, in addition to their high cost, often have the disadvantage of being inconvenient to use and also difficult to clean.

In order to overcome this disadvantage, in accordance with the document FR 2 825 043, a simple, practical and inexpensive manual vegetable cutter has been proposed which enables the cutting characteristics to be varied selectively.

This known device, which is referred to by experts as a “slicer” comprises:
a frame which is supported on feet, which can preferably be folded up, and which is provided with two parallel longitudinal uprights which define, on the one hand, two guiding rails for a carriage which can be moved back and forth in translation and which delimits, at the inner portion thereof, a space for receiving vegetables to be cut, and which are portion thereof, a space for receiving vegetables to be cut, and which are connected, on the other hand, by means of a plate which is mounted so as to be moveable in translation between these uprights, perpendicularly to the displacement axis of the carriage in order to allow the cutting width to be adjusted, and
at least one cutting blade which is mounted transversely between the longitudinal uprights facing an edge or first edge of the plate for adjusting the cutting width in order to define an aperture for the passage of the cut vegetables.

In a vegetable cutter of this type known from the prior art, the carriage is constituted, on the one hand, by a cylindrical guide chamber which is open at the upper portion thereof and which is provided, at the lower portion thereof, with a substantially rectangular collar, two of the opposing edges of which are folded down in order to define two grooves which co-operate with the guiding rails and, on the other hand, by a push-button which fits on or in the guide chamber and which is intended to be gripped manually by the user in order to move the carriage along the guiding rails with a pressure being applied continuously to the vegetables which are contained in the receiving space in order to press them against the cutting blade and allow them to be cut by this blade.

This safety vegetable cutter has the advantage of enabling many different types of preparation to be readily performed (smooth or corrugated discs, crinkle-cutting, dicing, . . . ) and has therefore been very well received by users.

It also has many other advantages which are connected, in particular, to its compactness for storage, and also its easy maintenance, particularly using a dishwasher.

However, it has been found from experience that the adjusting system for the cutting blades can be difficult to manipulate and may also expose users to cutting risks.

The object of the present invention is therefore to improve a known vegetable cutter of this type according to the prior art.

To this end, the invention relates to a manual safety vegetable cutter of the above-mentioned type, characterised in that it is provided with at least one disc-cutting cartridge constituted by a substantially flat removable element which can be inserted longitudinally between the uprights of the frame and which comprises a first edge, on which the cutting blade is mounted, a second edge facing the first, as well as two lateral edges, this disc-cutting cartridge being provided with gripping means which co-operate with positioning means which are provided on the frame.

This manual safety vegetable cutter is therefore distinguished substantially from the known vegetable cutter in that the cutting blade is mounted on a disc-cutting cartridge which is intended to be inserted, not transversely but longitudinally, between the uprights of the frame, which is found to be more practical and less dangerous for the user.

According to the invention, the positioning means preferably comprise, on the one hand, at least two pairs of longitudinal lugs which are located facing each other on the inner face of each respective upright in order to define guiding slides for the lateral edges of the disc-cutting cartridge, close to the first edge thereof which is provided with the cutting blade, and which co-operate with a pair of transverse lugs which form a stop for this first edge and, on the other hand, elements for retaining the disc-cutting cartridge in the region of the second edge thereof.

In order to position the cartridge, the user therefore only has to grip the cartridge and then insert it into the guiding slides and move it in longitudinal translation until it comes into abutment.

The elements for retaining the disc-cutting cartridge in the region of the second edge thereof can themselves simply be constituted by one or more support stop(s) which is/are provided on a fixed element of the frame in the central portion thereof, or at one side and the other on the longitudinal uprights, and on which the disc-cutting cartridge is supported.

The elements for retaining this cartridge are, however, preferably constituted by two resiliently deformable hooks which are located facing each other on the respective lateral edges thereof and which are each provided with a retaining stud which can be snapped into holes which are drilled for this purpose in the uprights of the frame.

According to another feature of the invention, the gripping means are constituted by two safety notches which are located facing each other on the respective lateral edges of the disc-cutting cartridge, close to the second edge of this cartridge.

These notches can advantageously co-operate with finger holes which are provided in the longitudinal uprights of the frame in order to facilitate the positioning of the disc-cutting cartridge.

These safety notches can also advantageously be provided in the region of the resiliently deformable hooks located facing each other on the respective lateral edges of the disc-cutting cartridge in order to facilitate the gripping of this cartridge.

According to a preferred feature of the invention, the cutting blade mounted on the first edge of the disc-cutting cartridge is a V-shaped blade.

The advantage of a blade of this type is to be able to provide knives which are capable of gripping the vegetables to be cut at both sides, which is preferable in the case of relatively soft vegetables, and in particular tomatoes, which are difficult to cut with a straight blade since they have a tough skin and soft flesh.

This V-shaped cutting blade can further advantageously be corrugated in order to allow corrugated discs of variable width to be cut, or even cutting of the “crinkle” type, if the push-button which fits in or on the guide chamber is rotated by 180° with each back and forth movement of the carriage.

A blade of this type in particular allows tomatoes to be crinkle-cut which was previously impossible.

According to another preferred feature of the invention, the vegetable cutter is also provided with at least one removable baton-cutting cartridge or julienne cartridge which can be inserted longitudinally between the uprights of the frame below the disc-cutting cartridge and which comprises an active face which is provided with a series of longitudinal-cutting blades which are directed transversely and which are intended to be positioned facing this cartridge.

This julienne cartridge is therefore also inserted longitudinally between the uprights of the frame, in the same manner as the disc-cutting cartridge but in the lower portion of the plate for adjusting the cutting width.

To this end, the julienne cartridge can advantageously be provided with a positioning tongue which facilitates the positioning thereof and which further allows the longitudinal-cutting blades to be protected.

It should be noted that, in the context of this description, the terms lower and upper or below and above must be understood with the vegetable cutter being considered in a position for use resting on a horizontal support, whilst the term front corresponds, still in this position, to the lowest end of the frame and the term rear to the highest end thereof.

According to the invention, the julienne cartridge can advantageously be constituted by a substantially triangular element which comprises, on the one hand, a first edge which is located facing the first edge of the plate for adjusting the cutting width and which is intended to abut plates which are mounted for this purpose between the uprights of the frame and to be locked in position by a slide which can be moved in apertures of these uprights and, on the other hand, two lateral edges which are separated by a positioning peak which is provided, in the region of the edge thereof, with a recess which is intended to be inserted in a central shoulder of a transverse centering bar which separates the two uprights of the frame.

Given this configuration, the julienne cartridge can be mounted on the frame between the lateral uprights thereof in as simple and rapid a manner as the disc-cutting cartridge.

According to the invention, it was found that cutting was more straightforward if the plate for adjusting the cutting width and the cutting cartridges were inclined at an angle of approximately 45° relative to the longitudinal axis thereof.

Consequently, and according to a particularly advantageous feature of the invention, the feet of the frame of the vegetable cutter have a shape which allows such an inclination to be achieved.

This shape is preferably selected so that the vegetable cutter can be handled both in a straight position and in an inclined position.

It has been found to be advantageous to shape the front foot in a symmetrical manner and the rear foot in an asymmetrical manner.

The rear foot can also advantageously be introduced into holes of the uprights of the frame with force in order to be able to be positioned in one direction or the other so that the vegetable cutter can be operated by either a right-handed or a left-handed user.

During the cutting operation, the user can advantageously press on an ergonomically shaped lateral handle which is fixed to the elements for adjusting the cutting width.

According to another feature of the invention, the vegetable cutter is provided with a crank for micrometric adjustment of the cutting width.

The features of the safety vegetable cutter which is the subject-matter of the invention will be described in greater detail with reference to the appended drawings, in which:

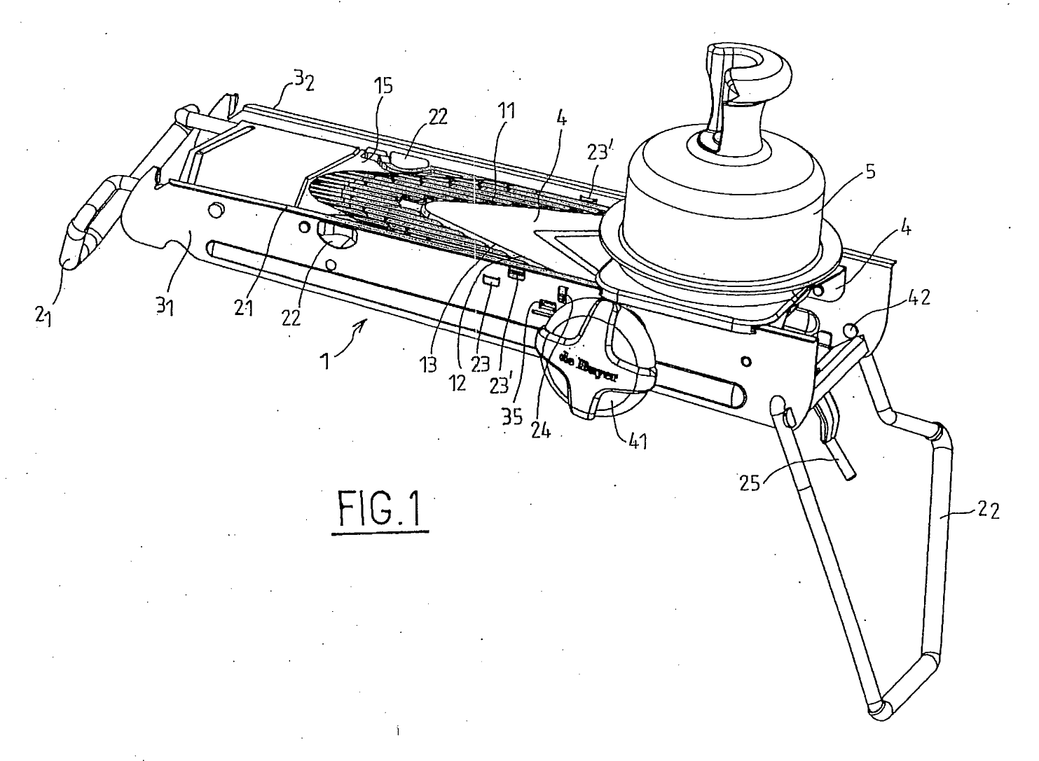

FIG. 1 is a perspective view showing the upper face of the vegetable cutter,

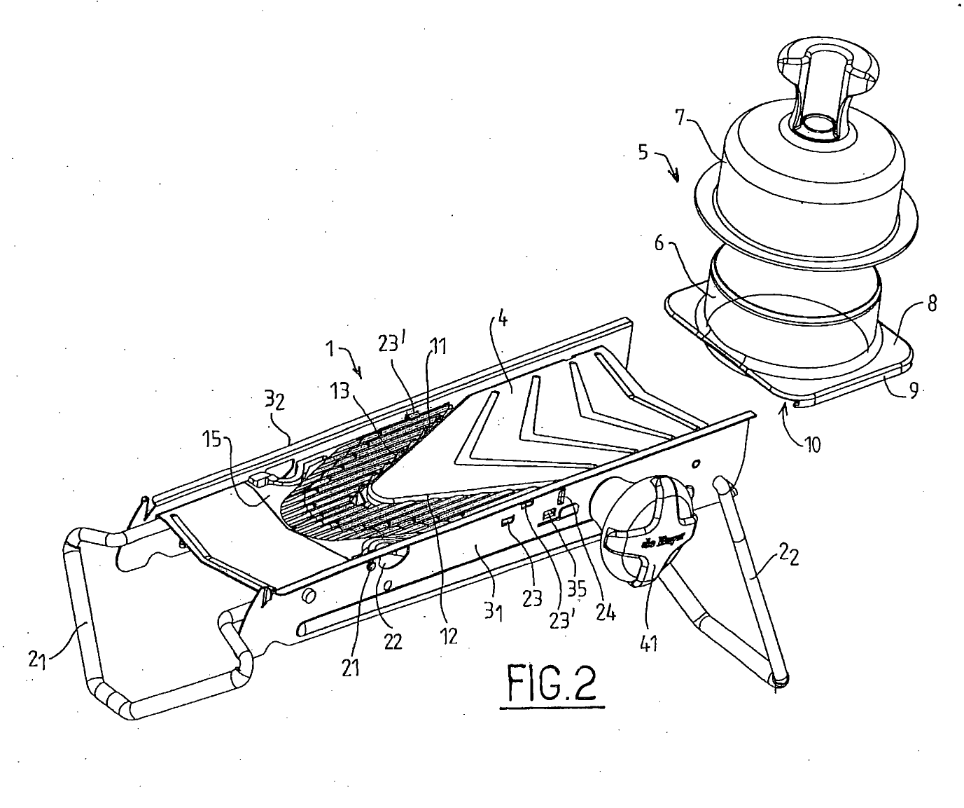

FIG. 2 is a perspective view which corresponds to FIG. 1 but in which the carriage has been disassembled and is shown as an “exploded view”,

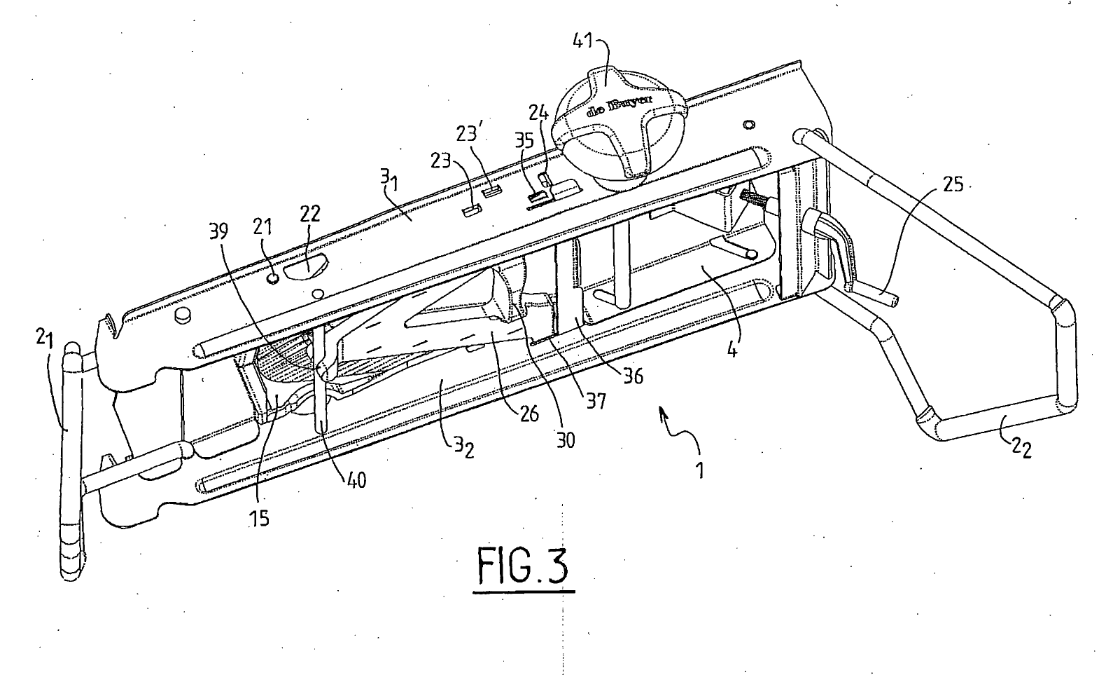

FIG. 3 is a perspective view showing the lower face of the vegetable cutter,

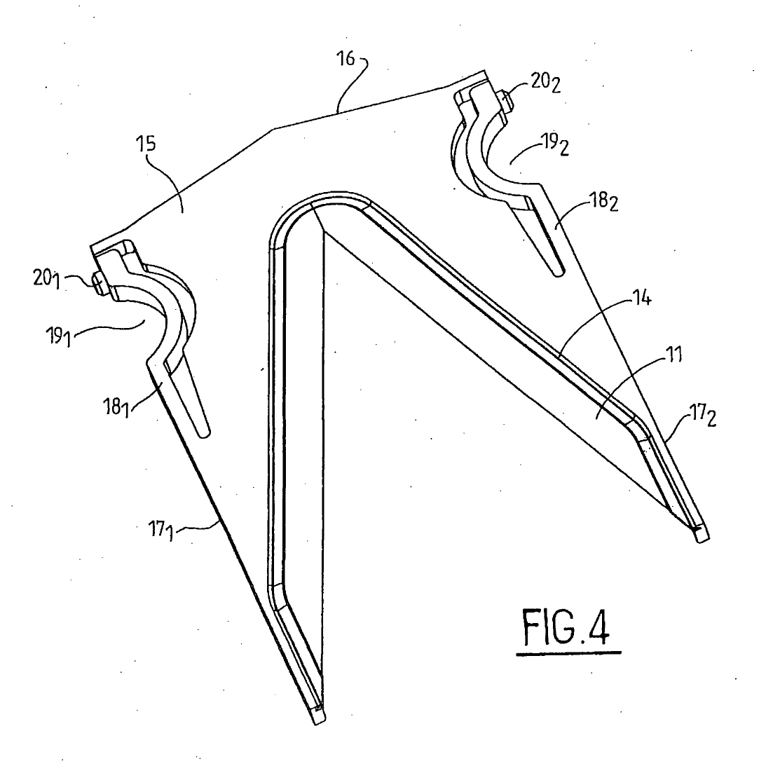

FIG. 4 is a perspective view of a disc-cutting cartridge,

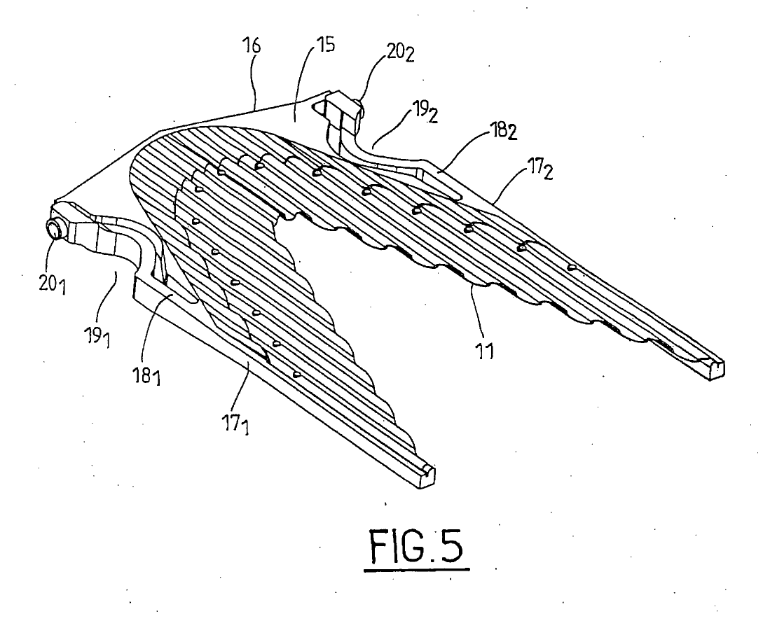

FIG. 5 is a perspective view of a variant of the disc-cutting cartridge,

FIG. 6 is a perspective view showing the active face of a julienne type cutting cartridge,

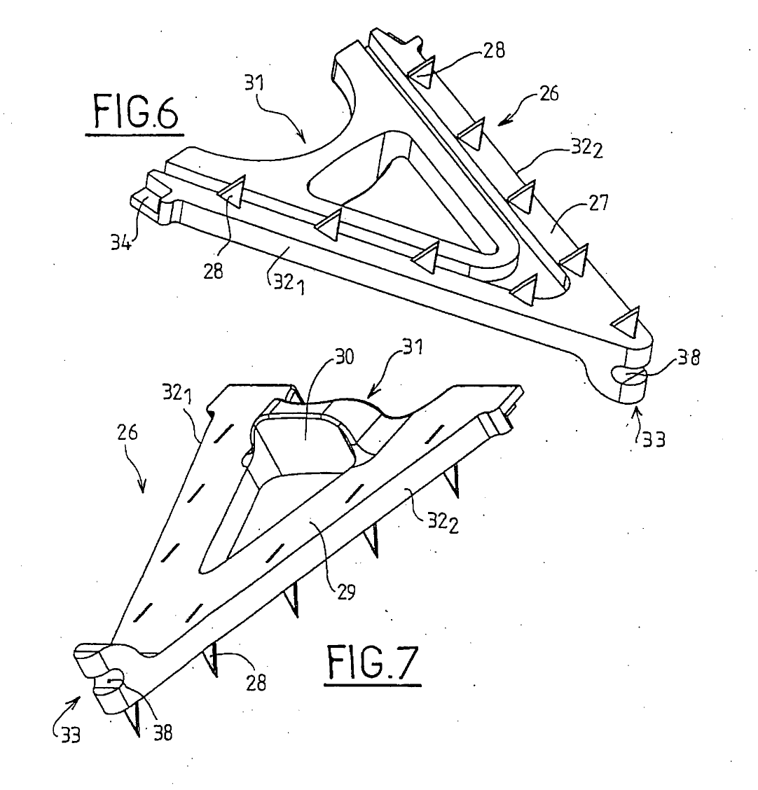

FIG. 7 is a perspective view corresponding to FIG. 6 but showing the opposite face of the julienne cartridge.

According to FIGS. 1 and 2, the vegetable cutter is substantially constituted by a frame 1 which is supported on two feet which can be folded back, that is to say, a front foot 2₁ and a rear foot 2₂.

The frame 1 comprises two parallel longitudinal uprights 3₁, 3₂, as well as a plate 4 which is mounted so as to be moveable in translation between these uprights in order to allow the cutting width to be adjusted.

The configuration of the plate 4 for adjusting the cutting width, which is shown in greater detail in FIG. 3, as well as that of the elements which allow it to be displaced between the uprights 3₁, 3₂, correspond to those described in document FR 2 825 043 and will not be set out in this instance for reasons of brevity.

According to FIG. 3, the frame 1 is provided with a crank 25 which co-operates with the plate 4 for adjusting the cutting width in order to allow a micrometric adjustment of this width.

According to FIGS. 1 and 2, the two parallel uprights 3₁, 3₂ define, at the upper portion thereof, two guiding rails for a carriage 5 which can be moved back and forth in translation along the guiding rails.

According to FIG. 2, the carriage 5 is constituted by the association of a guide chamber 6 and a push-button 7 which fits thereon.

The guide chamber 6 is constituted by a cylindrical element which is open at the upper portion thereof so as to delimit a receiving space for the vegetables to be cut and which is provided, at the lower portion thereof, with a substantially rectangular collar 8 whose two opposing edges 9 are folded down in order to define two grooves 10 which co-operate with the guiding rails 3₁, 3₂.

The configuration of the push-button 7 also corresponds to that of the push-button with which the vegetable cutter is provided which is described in document FR 2 825 043.

This push-button 7 is intended to be gripped manually by the user in order to move the carriage 5 along the guiding rails with a pressure being applied continuously to the vegetables contained in the guide chamber 6 in order to press them against a V-shaped cutting blade 11.

This blade 11 is mounted transversely between the longitudinal uprights 3₁, 3₂ facing a first edge 12 of the plate 4 for adjusting the cutting width in order to define an aperture 13 for the passage of the cut vegetables, which aperture is also in the shape of a “V”.

More precisely, and according to FIG. 4, the cutting blade 11 is a flat blade which is mounted on a first edge 14 of a disc-cutting cartridge 15 which is substantially flat and which is intended to be inserted longitudinally between the uprights 3₁, 3₂ of the frame 1 in the position shown in FIGS. 1 and 2.

According to FIGS. 1, 2 and 5, the disc-cutting cartridge 15 is provided with a V-shaped cutting blade 11 which is not flat but instead which is corrugated in order to allow corrugated or crinkled discs to be produced.

Of course, the vegetable cutter is generally provided with not just one, but a series of disc-cutting cartridges which have blades of different shapes in order to allow different types of disc to be produced.

According to FIGS. 4 and 5, the disc-cutting cartridge 1 comprises a second edge 16 opposite the first edge 14, on which the cutting blade 11 is mounted, as well as two lateral edges 17₁, 17₂ which are provided, close to the second edge 16, with resiliently deformable hooks 18₁, 18₂ which are provided, on the one hand, with gripping notches 19₁ and 19₂ and, on the other hand, at the free end thereof, with two retaining studs 20₁, 20₂ which are intended to snap into holes 21 which have been drilled for this purpose in the uprights 3₁, 3₂ of the frame 1 which are shown in FIGS. 1 and 2.

According to FIGS. 1 and 2, the uprights 3₁, 3₂ of the frame 1 are also provided with finger holes 22 which are located facing the gripping notches 19₁, 19₂ when the disc-cutting cartridge 15 is positioned in the central portion of the frame 1.

In order to allow this positioning, the frame 1 is further provided with two pairs of longitudinal lugs 23, 23′ which are located facing each other on the inner face of each respective upright 3₁, 3₂ in order to define guiding slides of the lateral edges 17₁, 17₂ of the disc-cutting cartridge 16 close to the first edge 14 thereof which is provided with the cutting blade 11.

These longitudinal positioning lugs 23, 23′ co-operate, respectively, with a pair of transverse lugs 24 which form a stop for this first edge 14 of the disc-cutting cartridge 15.

In order to position the cartridge 15, the user must grip the cartridge by the gripping notches 19₁, 19₂, then introduce the lateral edges 17₁, 17₂ thereof into the slides defined by the positioning lugs 23, 23′ until it comes into abutment with the transverse lugs 24.

When these elements are brought into abutment, the retaining studs 20₁, 20₂ with which the resiliently deformable hooks 18₁, 18₂ are provided automatically snap into the holes 21 drilled in the uprights 3₁, 3₂ of the frame 1.

According to FIGS. 1 and 2, the configuration of the feet 2₁, 2₂ which can be folded back is selected so as to allow the user to handle the vegetable cutter in a straight position but also in a position in which the plate 4 for adjusting the cutting width and the disc-cutting cartridge 15 are inclined at an angle of approximately 45° relative to the longitudinal axis of the frame 1, which position is found to be more practical for use.

During this operation, the user may press on an ergonomic handle 41 which is fixed to the elements for adjusting the cutting width.

According to FIGS. 1 and 2, the front foot 2₁ has a symmetrical shape, whilst the rear foot 2₂ is asymmetric.

The rear foot 2₂ is introduced with force in holes 42 which are provided for this purpose in the lateral uprights 2₁, 2₂ of the frame 1 in order to allow this foot to be mounted in one direction or another so that the vegetable cutter can be operated by either a right-handed or a left-handed user.

According to FIGS. 3, 6 and 7, the vegetable cutter is further provided with a removable baton-cutting cartridge or julienne cartridge 26, which is also intended to be inserted longitudinally between the uprights 3₁, 3₂ of the frame 1 below the disc-cutting cartridge 15 in the position shown in FIG. 3.

According to FIGS. 6 and 7, this julienne cartridge 26 is constituted by a substantially triangular element which is hollowed out in the central portion thereof and which comprises, on the one hand, an active face 27 which is illustrated in FIG. 6 and which is provided with a series of longitudinal-cutting blades 28 which are directed transversely and which are intended to be positioned facing the disc-cutting cartridge 15 and, on the other hand, a gripping face 29 which is illustrated in FIG. 7 and which is located facing the active face 27 and which is provided with a positioning tongue 30.

These two faces 27, 29 are delimited by a first edge 31 which comprises a curved recess and by two lateral edges 32₁, 32₂ which are separated by a positioning peak 33.

When the julienne cartridge 26 is positioned in the central portion of the frame 1 in the position shown in FIG. 3, the first edge 31 thereof is located facing the first edge 14 of the plate 15 for adjusting the cutting width.

The active face 27 of the julienne cartridge 26 is provided, in the region of this first edge 31, with two shoulders 34 which are intended to co-operate with two plates which form a stop 35 and which are mounted for this purpose between the uprights 3₁, 3₂ of the frame 1, as shown in FIG. 3.

A slide 36 which can be moved in translation in apertures 37 of the uprights 3₁, 3₂ allows the julienne cartridge to be locked in this position.

According to FIGS. 6 and 7, the julienne cartridge 26 is further provided, at the edge thereof, in the region of the positioning peak 33, with a positioning recess 38.

According to FIG. 3, when the julienne cartridge 26 is positioned in the central portion of the frame 1, the recess 38 is inserted in a central shoulder 39 of a transverse centering bar 40 which separates the two uprights 3₁, 3₂ of the frame 1.

The positioning of the julienne cartridge 26 is as simple and rapid as that of the disc-cutting cartridge 15.

After the frame 1 has been turned over, the user must grip this cartridge 26 by the positioning tongue 30, then introduce the recess 38 in the shoulder 39 of the centering bar 40 and bring the shoulders 34 into contact with the plates 35; the slide 36 then simply has to be displaced in translation in the apertures 37 of the uprights 3₁, 3₂ so that it overlaps the face 29 of the julienne cartridge 26 and locks it in position.

1. Manual safety vegetable cutter comprising:
a frame which is supported on feet, and which is provided with two parallel longitudinal uprights which define two guiding rails for a carriage which can be moved back and forth in translation and which delimits, at an inner portion thereof, a space for receiving vegetables to be cut, which guide rails are connected by a plate which is mounted so as to be moveable in translation between the uprights, perpendicularly to the displacement axis of the carriage in order to allow the cutting width to be adjusted, and
at least one cutting blade which is mounted transversely between the longitudinal uprights facing an edge or first edge of the plate, for adjusting the cutting width in order to define an aperture for the passage of the cut vegetables,
the carriage comprising:
a cylindrical guide chamber which is open at the upper portion thereof and which is provided, at the lower portion thereof, with a substantially rectangular collar, two of the opposing edges of which are folded down in order to define two grooves which co-operate with the guiding rails, and
a push-button which fits on or in the guide chamber and which is intended to be gripped manually by the user in order to move the carriage along the guiding rails with a pressure being applied continuously to the vegetables contained in the receiving space in order to press the vegetables against the cutting blade and allow the vegetables to be cut by the blade, and
at least one disc-cutting cartridge comprising a substantially flat removable element which can be inserted longitudinally between the frame uprights and which comprises a first edge on which the cutting blade is mounted, a second edge facing the first edge, and two lateral edges, the disc-cutting cartridge being provided with gripping means which co-operate with positioning means which are provided on the frame.

2. Vegetable cutter according to claim 1, wherein the positioning means comprise
at least two pairs of longitudinal lugs which are located facing each other on the inner face of each respective upright in order to define guiding slides for the lateral edges of the disc-cutting cartridge, close to the first edge thereof which is provided with the cutting blade, and which co-operate with a pair of transverse lugs which form a stop for the first edge, and
elements for retaining the disc-cutting cartridge in the region of the second edge thereof.

3. Vegetable cutter according to claim 2, wherein the elements for retaining the disc-cutting cartridge comprise two resiliently deformable hooks which are located facing each other on the respective lateral edges of the disc-cutting cartridge and which are each provided with a retaining stud which can be snapped into holes in the uprights of the frame.

4. Vegetable cutter according to claim 1, wherein the gripping means are constituted by two safety notches which are located facing each other on the respective lateral edges of the disc-cutting cartridge close to the second edge of the disc-cutting cartridge.

5. Vegetable cutter according to claim 4, wherein the safety notches co-operate with finger holes in the uprights of the frame.

6. Vegetable cutter according to claim 1, wherein the cutting blade mounted on the first edge of the disc-cutting cartridge is a V-shaped blade.

7. Vegetable cutter according to claim 6, wherein the cutting blade is a corrugated blade.

8. Vegetable cutter according to claim 1, comprising at least one removable baton-cutting cartridge or julienne cartridge which can be inserted longitudinally between the frame uprights below the disc-cutting cartridge, which removable cartridge comprises an active face which is provided with a series of longitudinal-cutting blades which are directed transversely and which are intended to be positioned facing the disc-cutting cartridge.

9. Vegetable cutter according to claim 8, wherein the julienne cartridge is provided with a positioning tongue.

10. Vegetable cutter according to claim 8, wherein the julienne cartridge comprises a substantially triangular element which comprises
a first edge which is located facing the first edge of the plate for adjusting the cutting width and which is intended to abut plates which are mounted for this purpose between the frame uprights and to be locked in position by a slide which can be moved in apertures of the frame uprights, and two lateral edges which are separated by a positioning peak which is provided, in the region of the edge thereof, with a recess which is intended to be inserted in a central shoulder of a transverse centering bar which separates the two frame uprights.

11. Vegetable cutter according to claim 1 wherein the feet of the frame have a shape which allows the plate for adjusting the cutting width and the cutting cartridges to be inclined at an angle of approximately 45° relative to the longitudinal axis thereof.

12. Vegetable cutter according to claim 1, further comprising a crank for micrometric adjustment of the cutting width.
